(19) United States
(12) Patent Application Publication
(10) Pub. No.: US 2022/0037978 A1
(43) Pub. Date: Feb. 3, 2022

(54) MAGNETIC GENERATOR AND ELECTRIC POWER GENERATION SYSTEM COMPRISING SUCH A GENERATOR

(71) Applicant: Arif CECEN, Paris (FR)

(72) Inventor: Arif CECEN, Paris (FR)

(21) Appl. No.: 17/389,706

(22) Filed: Jul. 30, 2021

(30) Foreign Application Priority Data
Aug. 3, 2020 (FR) 2008238
Mar. 9, 2021 (FR) 2102284

(51) Int. Cl. H02K 53/00; H02K 16/00; H02K 1/27; H02K 7/18; H02J 3/32

(52) U.S. Cl. CPC H02K 53/00; H02K 16/00; H02J 3/32; H02K 7/1807; H02K 1/27

(57) ABSTRACT

The invention relates to a magnetic generator (1) comprising at least one rotary drive means (2) having an axle associated with an actuator system, the actuator system comprising at least one induction rotor (5) associated with the axle of the rotary drive means (2), the induction rotor (5) comprising magnetic inductor structures (6), the induction rotor (5) being associated with at least one induced rotor (7) comprising induced magnetic structures (8) configured so as to cooperate with the inductive magnetic structures (6) so that the inductive magnetic structures (6) driven by the induction rotor (5) cause the induced structures (7) and the induced rotor (6) to rotate, said induced rotor (6) being associated with an electric power generation means (9).

### CROSS-REFERENCE TO RELATED APPLICATIONS

This application claims the benefit of priority of French Patent Application Nos. FR 2102284 filed Mar. 9, 2021, and FR 2008238 filed August 3, 2020, both of which are incorporated by reference in their entireties.

### DESCRIPTION

The invention relates to the field of power generators, particularly for producing electric power from an initial energy and conveying it to a power grid.

In this field, it is known to propose generators comprising a rotary system in combination with dynamoelectric-type means for producing current from the movements of the rotary system.

Unfortunately, these generators require the transmission of movements by mechanical means involving friction and hence unsatisfactory efficiency.

It is therefore an object of the present invention to provide a generator having greater efficiency than the actuators of the prior art, particularly by limiting friction during the transmission of movements.

A second object is to provide a generator having a simple construction and a long life cycle.

To achieve these objects, the invention relates to a magnetic generator comprising at least one rotary drive means having an axle associated with an actuator system, the actuator system comprising at least one induction rotor associated with the axle of the rotary drive means, the induction rotor comprising inductive magnetic structures, the induction rotor being associated with at least one induced rotor comprising induced magnetic structures that are configured so as to cooperate with the inductive magnetic structures so that the inductive magnetic structures driven by the induction rotor cause the induced structures and the induced rotor to rotate, said induced rotor being associated with electric power generation means.

Advantageously, the use of the motor and of the magnetic structures makes it possible to simplify the gearing.

Moreover, the use of magnets makes it possible to have entraining movements without friction between the rotors.

In addition, the use of rotors and magnetized structures makes it possible to produce a generator having a simple construction and a long life cycle.

According to other aspects taken in isolation or combined according to all of the technically feasible combinations:
at least one axle of at least one rotor or motor is mounted on the rest of the generator by means of magnetic stop;
the magnetic generator comprises at least two mutually associated induced rotors comprising induced magnetic structures that are configured so as to cooperate with one another so that the induced magnetic structures of at least one first induced rotor cause the induced magnetic structures of at least one second induced rotor to rotate, said induced rotors each being associated with electric power generation means; and/or
the magnetic generator comprises at least one Faraday cage structure upstream and downstream from the magnetic structures; and/or
the magnetic generator comprises at least one means for generating a vacuum at least around the actuator system; and/or
the magnetic structures comprise permanent magnets, particularly neodymium-based permanent magnets; and/or
the magnetic structures are arranged in a cylinder comprising magnetic elements on the surface of revolution; and/or
the magnetic structures cooperating together are configured so as to repel one another; and/or
the power generation means comprises one alternator per induced rotor axle, preferably in combination with a controller and inverter system; and/or
the magnetic generator comprises two motors associated with two induction rotors; and/or
said rotary drive means comprises at least one motor, preferably powered by a battery; and/or
the magnetic generator comprises two motors associated with two induction rotors.

Another object of the invention relates to an electric power generation system comprising a magnetic generator according to the invention connected to an apparatus for production of electric power which comprises said rotary drive means.

The invention will be further detailed through the description of non-limiting embodiments and on the basis of the appended figures, in which

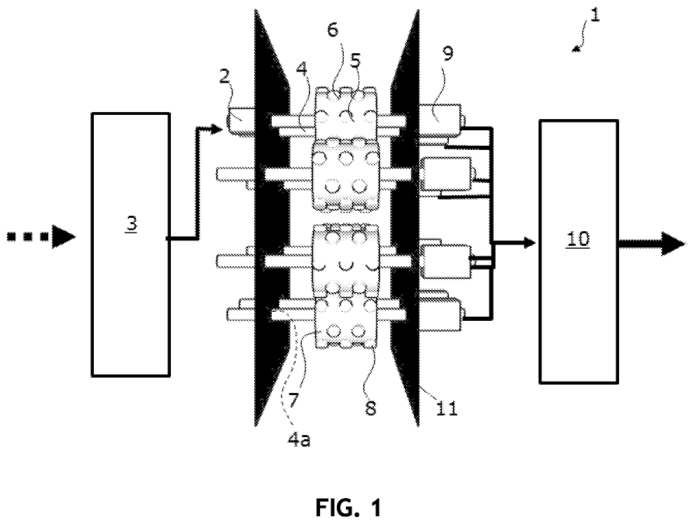

FIG. 1 is a schematic side view of a magnetic generator according to a first preferred variant of the invention;

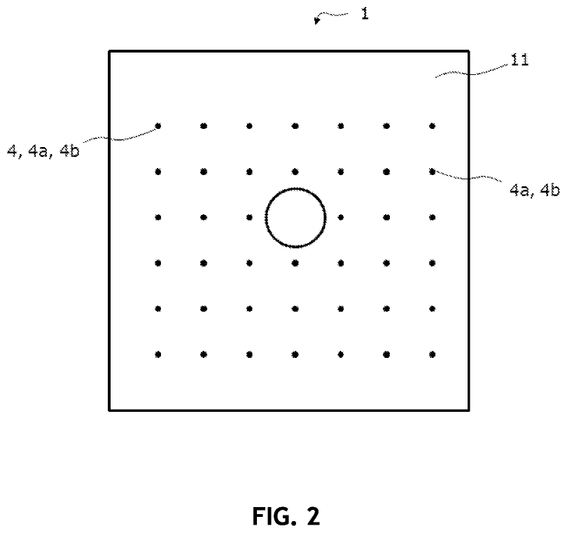

FIG. 2 is a schematic front view of the magnetic generator of FIG. 1; and

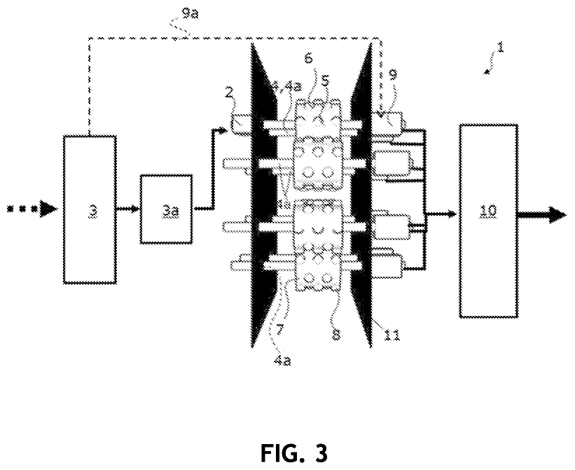

FIG. 3 is a schematic side view of a magnetic generator according to a second preferred variant of the invention.

The invention relates to a power generator 1, particularly for producing electric power and conveying it to a power grid.

It is a magnetic generator 1, namely a generator that makes use of magnetic forces.

This could be characterized as a planetary magnetic gear system that is connected to an electric multi-generator, or more simply as a magnetic gear.

The generator 1 comprises at least one rotary drive means 2. In a preferred variant, this is at least one motor. Depending on the variant used, the generator can include more than one motor, The motor here is an electric motor which is associated with a rechargeable battery 3. The axle 4 of the motor is associated with an actuator system. The battery 3 is recharged from time to time from the mains supply.

The generator can comprise a voltage controller 3a (or voltage regulator) that enables a constant voltage to be maintained. As a result, the incoming current is less dependent on the charge state of the battery 3.

The actuator system comprises at least one induction rotor 5 which is associated with the axle of the motor 4. In particular, the induction rotor 5 is fixed to the axle of the motor 4. The motor transfers its torque to an induction rotor.

The induction rotor 5 comprises inductive magnetic structures 6. In particular, these are permanent magnets based on Neodymium (NdFeB). More particularly, the generator 1 is composed of a set of homogeneous magnetic rotors, mounted particularly in a closed loop—i.e., with magnetic structures that are both induced and inductive. In the preferred variant, the rotors are identical cylinders comprising magnets. The cylinders can be made of polymer in order to limit manufacturing costs, but other materials such as aluminum, carbon fiber, or non-ferrous materials can be used.

The induction rotor 5 is associated with at least one induced rotor 7 comprising induced magnetic structures 8. The induced rotor 7 can be of the same type as the induction rotor 5. The induced magnetic structures 8 of the induced rotor 7 are configured so as to cooperate with the inductive magnetic structures 6 of the induction rotor 5, so that the inductive magnetic structures 6 driven by the induction rotor 5 cause the induced structures 8 and the induced rotor 7 to rotate.

In particular, the cooperation takes place through magnetic forces. In the preferred variant, the magnetic structures 6, 8 repel one another so as to create and transfer a rotational force by virtue of the cylindrical structure, where a push and a pull are exerted.

Advantageously, the use of the motor 2 and of the magnetic structures 6, 8 makes it possible to simplify the gearing through the absence of contact.

Preferably, the axle(s) 4a of at least one, preferably all, of the rotating structures, namely the induction rotors 5 and induced rotors 7, and preferably the axle 4 of the engine 2, are mounted on the rest of the generator 1 by means of magnetic bearings 4b. These structures comprise a magnetic field in a rolling bearing so that there is no friction between the rotating parts of the bearing. Advantageously, the magnetic bearings 4b improve the efficiency of the system by limiting energy losses due to friction.

Moreover, the use of magnets makes it possible to have entraining movements without friction between the rotors 5, 7.

In addition, the use of rotors and magnetized structures makes it possible to produce a generator having a simple construction and a long life cycle. In fact, the life cycle of the magnetic properties provides for an average duration of 25 years, which corresponds to the life cycle of generator 1.

A closed-loop assembly allows each rotor to be both a driving element and a driven element.

By way of non-limiting example, the shaft in the cylinder (5, 7) has a thickness of approximately 10 mm; the length of the cylinder (5, 7) is about 100 mm; the width of the cylinder (5, 7) is about 70 mm.

The illustrated generator 1 has 8 cylinders (5, 7). The arrangement of magnets in a block can be in 4 groups of 3 or 2 rows. The number of magnets on the block can be 20.

By way of non-limiting example, the diameter of the magnets is approximately 10 mm; the thickness of the magnets is about 5 mm; the distance between the magnets in the block is about 21 mm (from the circumference).

The generator 1 can weigh about 100 kg. Therefore, it can be transportable and used directly.

Said induced rotor 7 is associated with electric power generation means 9. In particular, eight alternators (9) are connected to each central axle at the output. Preferably, these are three-phase alternators with a rectifier system. The generator can comprise an excitation current 9a from the battery to one or more alternators 9.

The corresponding electric power, which is conveyed into as many direct current flows as there are rotors equipped with an alternator, is routed to a central controller 10 (charge controller).

In the preferred variant, the controller 10 performs an integration of said electrical flows, then outputs one or more distinct direct current flows, particularly toward a power grid.

The controller 10 can be associated with an inverter 10a so as to obtain an alternating current at the output.

According to one variant, the magnetic generator 1 comprises at least two mutually associated induced rotors 7. The induced rotors 7 comprise induced magnetic structures 8 that are configured so as to cooperate with one another so that the induced magnetic structures 8 of at least one first induced rotor 7 cause the induced magnetic structures 8 of at least one second induced rotor 7 to rotate. In addition, said induced rotors 7 are each associated with an electric power generation means 9, particularly an alternator. This is repeated for the next induced rotor.

Advantageously, this arrangement makes it possible to transmit the effects of a single rotary drive means by means of a contactless and hence frictionless gear system. The rotors can be of different sizes depending on the desired use.

The axes of the rotors can be substantially parallel.

According to one variant, the magnetic generator comprises at least one Faraday cage structure 11 upstream and downstream from the magnetic structures. In particular, the rotors 4, 4a are mounted directly on Faraday cage panels 11 by means of the magnetic stops 4b.

Advantageously, a Faraday cage 11 makes it possible to maintain the fields in the generator and not to disturb the elements external to the generator which are sensitive to magnetic fields.

According to one variant, the magnetic generator comprises at least one means for generating a vacuum at least around the actuator system.

Advantageously, this makes it possible to limit the friction of the air and to increase the efficiency of the generator.

In particular, the magnetic rotors are integrated into a Faraday cage under vacuum in order to avoid any contact with an external environment. Air that can be assimilated to a mechanical force is also removed from the system.

In the case of identical cylinders, these transmit their torque efficiently to one another with a substantial level of efficiency.

### EXAMPLE

A generator according to the invention can be provided with one or two motors (2) operating with a 12 V or 24 V or 48 V DC battery.

The rotary cylinders 5, 7 consist of 16-17 pieces 6, 8. In the current model, the alternators connected to the cylinders 5, 7 produce 12/24/48 V DC under the effect of rotation. Each alternator generates a power of 1 kW for a total of 6-8 kW of electricity.

The electricity produced is conveyed to a DC/AC inverter over integrated circuits. The batteries connected to the motors are controlled by a central controller. 230/320 V AC electricity is supplied by a ready-to-use inverter.

In another embodiment, the invention is an electric power generation system based on equipment for the production of electric power, which may be a wind turbine or a turbine of a mechanical generator. In this case, the turbine forms, or is complementary to, the rotary drive means 2 of the generator according to the invention, which drives the induction rotor 5.

Advantageously, this makes it possible to increase the productivity of the production equipment tenfold.

1. A magnetic generator (1) comprising at least one rotary drive means (2) having an axle associated with an actuator system, the actuator system comprising at least one induction rotor (5) associated with the axle of the rotary drive means (2), the induction rotor (5) comprising magnetic inductor structures (6), the induction rotor (5) being associated with at least one induced rotor (7) comprising induced magnetic structures (8) configured so as to cooperate with the inductive magnetic structures (6) so that the inductive magnetic structures (6) driven by the induction rotor (5) cause the induced structures (7) and the induced rotor (6) to rotate, said induced rotor (6) being associated with an electric power generation means (9).

2. The magnetic generator (1) according claim 1, characterized in that at least one axle (4, 4a) of at least one rotor (7, 8) or motor (2) is mounted on the rest of the generator (1) by means of magnetic stops (4b).

3. The magnetic generator (1) according to claim 1, comprising at least two mutually associated induced rotors (7) comprising induced magnetic structures (8) that are configured so as to cooperate with one another so that the induced magnetic structures (8) of at least at least one first induced rotor (7) cause the induced magnetic structures (8) of at least one second induced rotor (7) to rotate, said induced rotors (7) each being associated with electric power generation means (9).

4. The magnetic generator (1) according to claim 1, comprising at least one Faraday cage structure (11) upstream and downstream from the magnetic structures (6, 8).

5. The magnetic generator (1) according to claim 1, comprising at least one means for generating a vacuum at least around the actuator system.

6. The magnetic generator (1) according to claim 1, characterized in that the magnetic structures (6, 8) comprise permanent magnets, particularly neodymium-based permanent magnets.

7. The magnetic generator (1) according to claim 6, characterized in that the magnetic structures (6, 8) are arranged in a cylinder comprising magnetic elements on the surface of revolution.

8. The magnetic generator (1) according to claim 1, characterized in that the magnetic structures (6, 8) cooperating together are configured so as to repel one another.

9. The magnetic generator (1) according to claim 1, characterized in that the power generation means comprises one alternator per induced rotor axle, preferably associated with a controller (10) and inverter system.

10. The magnetic generator (1) according to claim 1, said rotary drive means comprising at least one motor which is preferably powered by a battery (3).

11. The magnetic generator (1) according to claim 10, comprising two motors (2) that are associated with two induction rotors (5).

12. An electric power generation system, comprising a magnetic generator according to claim 1 that is connected to an apparatus for production of electric power comprising said rotary drive means (2).
